(19) United States
(12) Patent Application Publication
(10) Pub. No.: US 2021/0090162 A1
(43) Pub. Date: Mar. 25, 2021

(54) SCORECARDS ENSEMBLE ALGORITHM AND APPROACHES

(71) Applicant: Wells Fargo Bank, N.A., San Francisco, CA (US)

(72) Inventors: Weicheng Liu, Winston Salem, NC (US); Vijayan N. Nair, Matthews, NC (US); Agus Sudjianto, Charlotte, NC (US); Daniel Kern, Charlotte, NC (US)

(21) Appl. No.: 15/703,429

(22) Filed: Sep. 13, 2017

Related U.S. Application Data
(60) Provisional application No. 62/394,505, filed on Sep. 14, 2016.

(51) Int. Cl. G06Q 40/02

(52) U.S. Cl. CPC G06Q 40/025

(57) ABSTRACT

Generating, modeling, and operating optimal scorecards for credit risk evaluations is provided to a financial institution. Customer data is aggregated from a set of customer accounts. A score is generated for each product offered by a financial institution, where each score contributes to a plurality of combinations of scores. An aggregated model is generated based on the aggregated customer data and the generated scores. An aggregated score is computed using the aggregated model. In aspects of the subject innovation, the systems and methods disclosed leverage data from several sources and to include internal competitive and external competitive data to provide a more focused view of the consumer.

### CROSS-REFERENCE TO RELATED APPLICATION

This application claims the benefit of U.S. Provisional Patent Application Ser. No. 62/394,505, entitled “SCORECARDS ENSEMBLE ALGORITHM AND APPROACHES” filed on Sep. 14, 2016. The entirety of the above-noted application is incorporated by reference herein.

### BACKGROUND

Current methods being used by the financial industry to assess consumer credit risk have been criticized for having disconnected single views instead of information across multiple business products. Current methods fail to capture joint information about customers that are present in each base model or scorecard. The failure leads to inefficient decisions and/or inferior operations. Efforts to combine information across individual scorecards have been subjective and are not scientifically based. Developing an optimal data-based solution to this problem is challenging due to heterogeneity and complexity of data from multiple sources and the need to link them and access the data quickly.

### BRIEF DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of generating, modeling, and operating optimal scorecards for credit risk evaluations. In aspects of the subject innovation, systems and methods are disclosed to leverage data from several sources and to include internal competitive and external competitive data to provide a more focused view of the consumer.

A method of the subject innovation can begin by aggregating customer data from a set of customer accounts. A score is generated for each product offered by a financial institution, wherein each score contributes to a plurality of combinations of scores. An aggregated model is generated based on the aggregated customer data and the generated scores.

A system of the subject innovation includes a data aggregator that collects customer data from a set of customer accounts. The system includes an optimization component that generates a score for each product offered by a financial institution, wherein each score contributes to a plurality of combinations of scores. The system also includes a modeling component that generates an aggregated model score based on the aggregated customer data and the generated scores.

A computer readable medium has instructions to control one or processors to aggregate customer data from a set of customer accounts. The instructions can generate a score for each product offered by a financial institution, wherein each score contributes to a plurality of combinations of scores. The instructions can generate an aggregated model score based on the aggregated customer data and the generated scores.

In aspects, the subject innovation provides substantial benefits in terms of increased computational reliability and greater predictive performance. One advantage resides in factoring prior knowledge to capture the holistic credit risk of a customer.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a credit risk system.

FIG. 2 illustrates an example component diagram of a modeling component.

FIG. 3 illustrates an example method for generating a credit risk model.

FIG. 4 illustrates an example method for determining the credit risk of a customer.

FIG. 5 illustrates a computer-readable medium or computer-readable device comprising processor-executable instructions configured to embody one or more of the provisions set forth herein, according to some embodiments.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

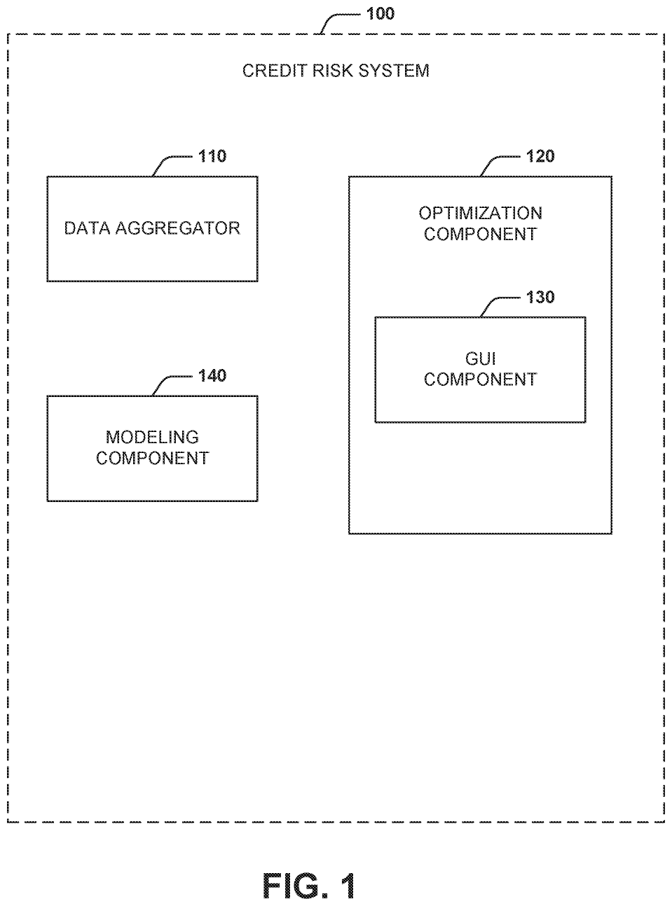

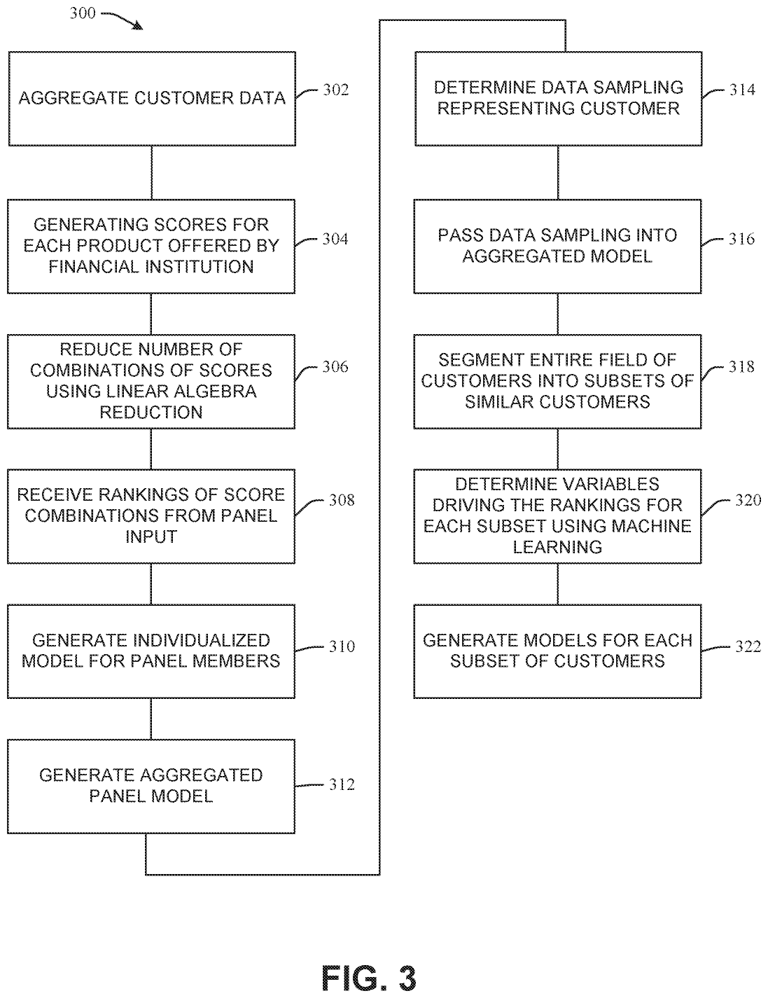

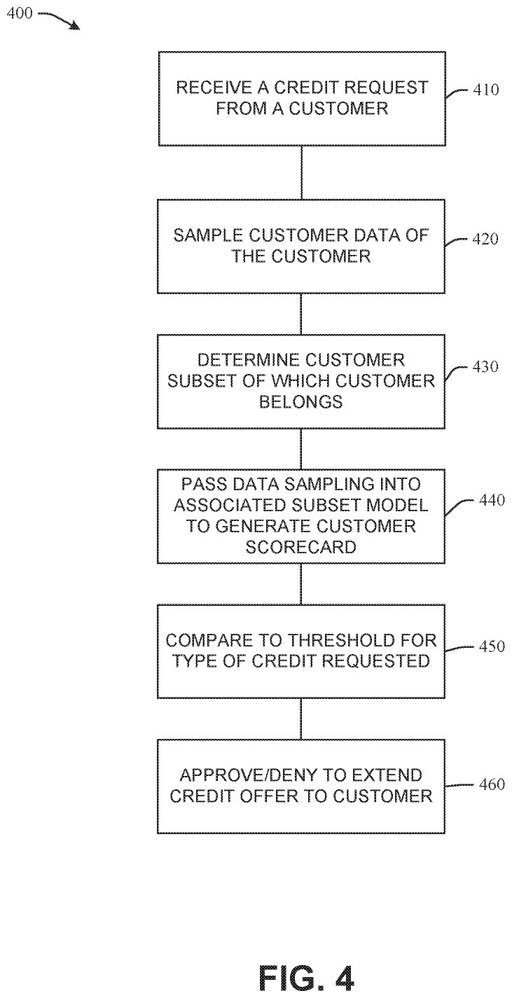

With reference to FIG. 1, a credit risk system 100 is depicted. The credit risk system 100 leverages a data harbor process to ingest baseline data across multiple business units. For example, a financial institution has business units for auto-lending, credit cards, etc. and provides a holistic scorecard on each customer (e.g. customer account). The credit risk system 100 provides one platform for different transactions, products, segment perspectives or the like. The credit risk system 100 can determine a scorecard on the customer account level using logic that includes an algorithmic method. The logic and algorithmic method is described in detail in FIGS. 3 and 4. The credit risk system 100 finds (or generates) an optimal combination of levels of scorecards associated with different products. The credit risk system 100 provides conjoint analysis for a series of trade-offs along with utility function defined by risk. The credit risk system 100 can create a combination solution of utilizing various scorecards. The solution is achieved via the use of a data platform that provides a consolidated or aggregated data source.

The data aggregator 110 compiles customer account information from the various products offered by the financial institution. For example, where the customer has accounts with the auto-lending group of the financial institution, as well as a credit card with the financial institution, the data aggregator 110 compiles the account histories for each to be used in the logic (e.g., algorithmic method). In some embodiments, the data aggregator 110 periodically compiles the customer data such that data is readily available when a new credit request is received.

The system 100 includes an optimization component 120. The optimization component 120 generates a score for each product offered by the financial institution. Each score contributes to a plurality of combinations of scores. The optimization component 120 includes a Graphical User Interface (GUI) component 130. The GUI component 130 can accept panel input from a user. The panel input is described in detail below.

The credit risk system 100 includes a modeling component 130. The modeling component 140 generates models to determine scorecards as described in detail below. The modeling component 130 can generate and solve complex (e.g., linear algebra) equations to optimize scorecards and constraints.

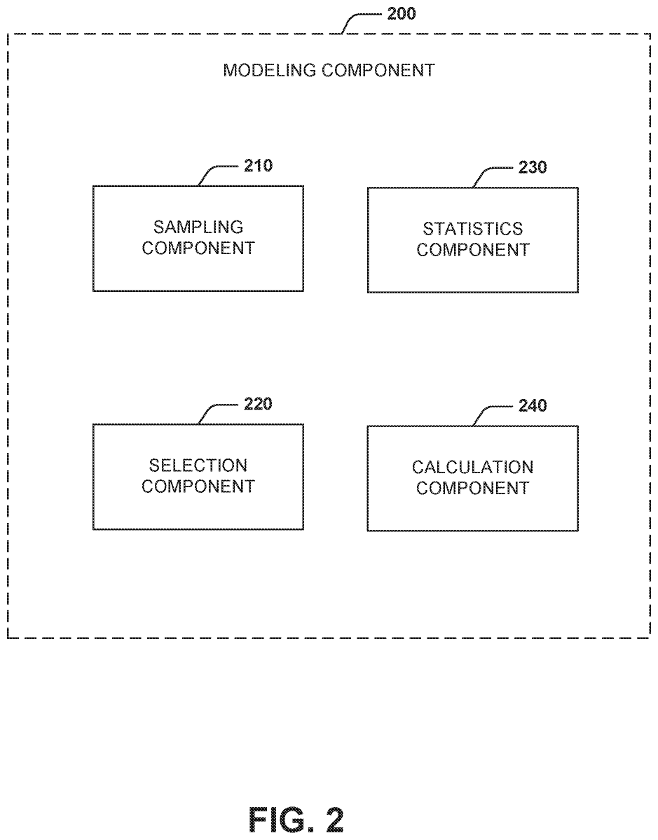

With reference to FIG. 2, an example component diagram of the modeling component 140 is depicted. The modeling component 140 generates an aggregated model from the aggregated data and product scores. The modeling component 140 includes a sampling component 210 that determines a data sampling approach representing a customer account. For example, a data sampling approach may be an average of all customer accounts.

The modeling component 140 includes a selection component 220 that segments the field of customer accounts into subsets of similar customers. The selection component 220 can group similar customers using the data from the customer accounts according to common factors, a similarity metric, and/or the like. The factors can include type of products used, net worth, services used, transaction statuses, and/or the like. The selection component 220 can employ similarity or matching algorithms to determine similar customer accounts. In some embodiments, the selection component 220 employs vector algorithms to determine distances between customer accounts.

The modeling component 140 includes a statistics component 230 that determines variables that affect the model the most for each subset of customer accounts. The statistics component 230 can employ constraints analysis to determine variables or constraints that affect the models. The higher affecting constraints can be used in further refining the aggregated model.

The modeling component 140 includes a calculation component 240 that reduces a plurality of combinations. The calculation component 240 receives the scores from the optimization component 120. The product scores can include a large amount of product combinations. The calculation component 240 can reduce the number of combinations using linear algebra techniques and/or the like. The reduction is described in further detail below.

The modeling component 140 can calculate a customer scorecard of a customer using the generated aggregated model. The modeling component 140 uses the customer's real financial information into the aggregated model to calculate the customer scorecard. The customer scorecard can be compared to thresholds to determine credit risk as described in FIG. 4 below.

With reference to FIG. 3, an example method 300 is depicted for determining a model to determine credit risk for a customer of a financial institution. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 300 is described in conjunction with a specific example is for explanation purposes.

In aspects, method 300 can begin at 302 by aggregating customer data from various data sources. The data sources can be located within a financial institution. External and cloud-based data sources may be accessed. The customer data can be related to a customer's credit history, financial data, and/or the like. The data can be aggregated on a periodic or continuous basis. At 304, scores are generated for each credit product offered by the financial institution. The scores can be a rating evaluation based on a score such as “good” vs. “bad” or “approve” vs. “reject.” In this example, the scores are generated for an example customer. The customer can be an existing customer or mimic information of an existing customer. The scores or ratings can be flagged as ‘good’, ‘bad’, or ‘don't know’ for each product of the financial institution. Other possible values could be used including a different scale or numeric values. For example, a financial institution may offer seven credit products to consumers. The total number of possible combinations of the three flags for seven products is 3\hat{ }7. At 306, the number of combinations is reduced to a smaller number that examines a balanced subset of all possible combinations, using efficient techniques in experimental design. The scores can be reduced using linear algebra reduction techniques and/or an equivalent technique. The scores are reduced to a smaller number of scores for further processing. This can be accomplished by using various Design of Experiment techniques or similar approaches.

At 308, rankings of the scores or ratings of the customer's profile for the different products are received from a panel input. The panel can be agents of the financial institution. One or members of the panel rank each of the combinations of scores or ratings according to effect on the credit risk. An alternative is for each member to rank only a subset of the combinations. This partial ranking can be accomplished through a balanced design.

At 310, an individualized model is generated for each panel member based on the rankings. At 312, the individualized models are compiled into an aggregated model. The panel members' input can also be aggregated and then the aggregated results are used to build the model. At 314, a data sampling representing a specific type of customer is determined. The data sampling can include a subset of the customer financial data.

At 316, the data sampling is passed into the aggregated model. At 318, the aggregated customer data is segmented into subsets of similar customers. In aspects, the subsets can be determined using machine learning techniques. At 320, the strongest variables that affect the aggregated model are determined for the subset of customers. The variables are determined using machine learning techniques. The variable selection changes according to the subset of customers. At 322, subset models are generated for each subset of customers according to the variable selection. The subset models are used for a customer in the associated subset that requests credit from the financial institution.

With reference to FIG. 4, a method 400 for approving/denying credit for a customer is depicted. The method 400 begins at 410 when a credit request is received from a customer. For example, a financial institution receives a credit request from a customer, such as a new credit card application. Data about the customer is aggregated and/or compiled to be passed into a credit risk algorithm. In some embodiments, data from all or almost all customers is aggregated for development of one or more credit risk models on a continuous basis. At 420, the customer data associated with a customer is sampled. The customer data is sampled to avoid data that may be outdated, irrelevant, and/or the like.

At 430, the customer subset is determined for the customer. At 440, the data sampling is passed into the subset model associated with the determined customer subset. The subset model is solved to determine a customer scorecard or score. At 450, the customer scorecard is compared to a threshold score for approval or denial of the credit request. There are different thresholds depending on the type of credit requested. For example, a customer scorecard can be 75. If a customer requested an auto-loan, the threshold may be 80, at which the customer would be denied the credit request. If a customer requested a new credit card, the threshold may be 70, at which the customer would be approved of the credit request. At 460, the approval or denial of the credit offer is relayed to the customer.

While the innovation is described with reference to the financial industry, it is to be appreciated that features, functions and benefits can be employed in other industries and settings without departing from the spirit and/or scope of the innovation and claims appended hereto. These alternative embodiments are to be included within the spirit and scope of the innovation and claims appended hereto.

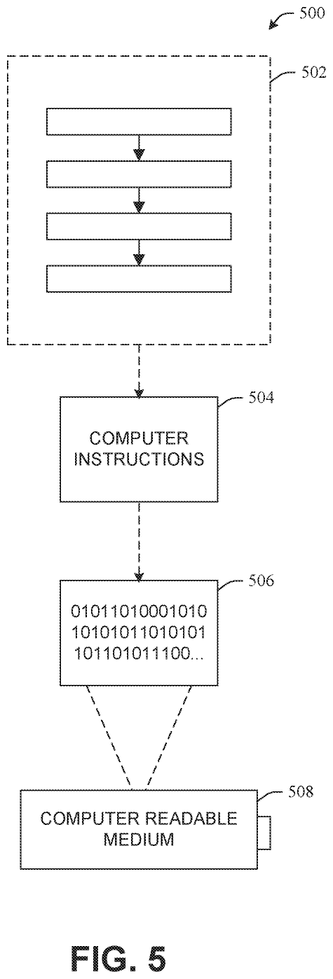

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 5, wherein an implementation 500 comprises a computer-readable medium 508, such as a CD-R, DVD-R, flash drive, a platter of a hard disk drive, etc., on which is encoded computer-readable data 506. This computer-readable data 506, such as binary data comprising a plurality of zero's and one's as shown in 506, in turn comprises a set of computer instructions 504 configured to operate according to one or more of the principles set forth herein. In one such embodiment 500, the processor-executable computer instructions 504 is configured to perform a method 502, such as at least a portion of one or more of the methods described in connection with embodiments disclosed herein. In another embodiment, the processor-executable instructions 504 are configured to implement a system, such as at least a portion of one or more of the systems described in connection with embodiments disclosed herein. Many such computer-readable media can be devised by those of ordinary skill in the art that are configured to operate in accordance with the techniques presented herein.

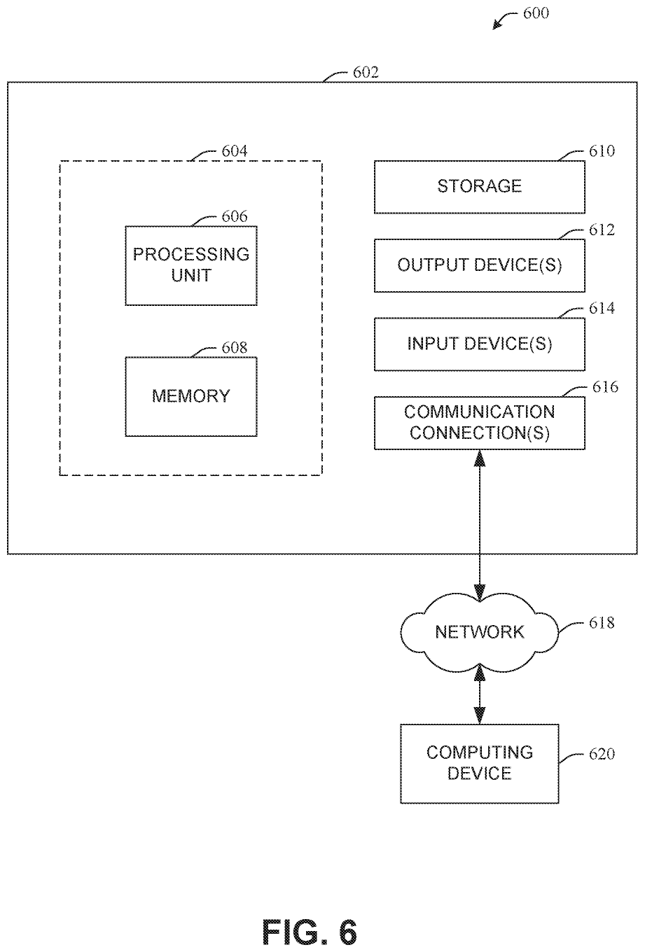

With reference to FIG. 6 and the following discussion provide a description of a suitable computing environment in which embodiments of one or more of the provisions set forth herein can be implemented. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 6 illustrates a system 600 comprising a computing device 602 configured to implement one or more embodiments provided herein. In one configuration, computing device 602 can include at least one processing unit 606 and memory 608. Depending on the exact configuration and type of computing device, memory 608 may be volatile, such as RAM, non-volatile, such as ROM, flash memory, etc., or some combination of the two. This configuration is illustrated in FIG. 6 by dashed line 604.

In these or other embodiments, device 602 can include additional features or functionality. For example, device 602 can also include additional storage such as removable storage or non-removable storage, including, but not limited to, magnetic storage, optical storage, and the like. Such additional storage is illustrated in FIG. 6 by storage 610. In some embodiments, computer readable instructions to implement one or more embodiments provided herein are in storage 610. Storage 610 can also store other computer readable instructions to implement an operating system, an application program, and the like. Computer readable instructions can be accessed in memory 608 for execution by processing unit 606, for example.

The term “computer readable media” as used herein includes computer storage media. Computer storage media includes volatile and nonvolatile, removable and non-removable media implemented in any method or technology for storage of information such as computer readable instructions or other data. Memory 608 and storage 610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 602. Any such computer storage media can be part of device 602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 602 can include one or more input devices 614 such as keyboard, mouse, pen, voice input device, touch input device, infrared cameras, video input devices, or any other input device. One or more output devices 612 such as one or more displays, speakers, printers, or any other output device can also be included in device 602. The one or more input devices 614 and/or one or more output devices 612 can be connected to device 602 via a wired connection, wireless connection, or any combination thereof. In some embodiments, one or more input devices or output devices from another computing device can be used as input device(s) 614 or output device(s) 612 for computing device 602. Device 602 can also include one or more communication connections 616 that can facilitate communications with one or more other devices 620 by means of a communications network 618, which can be wired, wireless, or any combination thereof, and can include ad hoc networks, intranets, the Internet, or substantially any other communications network that can allow device 602 to communicate with at least one other computing device 620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method, comprising:
executing, on a processor, instructions that cause the processor to perform operations comprising:
receiving a request for an approval of a credit offer by a customer, wherein the credit offer is associated with a product offered by a financial institution;
continuously aggregating customer data of a set of customer accounts from internal data sources, external data sources, and cloud data storage into an aggregated dataset, the set of customer accounts are associated with one or more the financial institutions, wherein the financial institution offers a set of products including at least the product associated with the credit offer;
generating a product score for each product offered by the financial institution, wherein each score contributes to a plurality of combinations of scores;
generating an aggregated model based on the aggregated dataset and the generated product score;
generating a subset model for a subset of similar customers, wherein generating the subset model comprises:
determining a data sampling representing a customer account
segmenting the field of customer accounts into subsets of similar customers;
modeling the data sampling using the aggregated model; and
determining variables that most affect the subset model for each subset of similar customers;
determining an aggregated score using the aggregated model and the aggregated dataset and the subset model and subset of customer accounts;
comparing the aggregated score to a variable threshold, wherein the variable threshold is determined according to a type of product offered and the credit offer requested; and
approving the request in real time if the aggregated score exceeds the variable threshold.

2. (canceled)

3. (canceled)

4. (canceled)

5. The method of claim 1, comprising:
reducing the plurality of combinations using techniques from a design of experiments.

6. The method of claim 1, comprising:
receiving rankings of the scores for a subset of combinations from a panel input.

7. The method of claim 6, comprising:
generating aggregated input from the panel input, wherein the panel input is made of users.

8. A system, comprising:
a processor coupled to a non-transitory memory that includes instructions that when executed by the processor cause the processor to:
receive a request for an approval of a credit offer by a customer, wherein the credit offer is associated with a product offered by a financial institution;
continuously collect customer data of a set of customer accounts from cloud data storage into an aggregated dataset, the set of customer accounts are associated with the financial institution, wherein the financial institution offers a set of products including at least the product associated with the credit offer;
generate a product score for each product offered by the financial institution, wherein each score contributes to a plurality of combinations of scores; and
generate an aggregated model based on the aggregated customer data and the generated product score;
generate a subset model for a subset of similar customers, wherein generating the subset model comprises:
determining a data sampling representing a customer account
segmenting the field of customer accounts into subsets of similar customers;
modeling the data sampling using the aggregated model; and
determining variables that affect the subset model the most for each subset of similar customers;
determine an aggregated score using the aggregated model and the aggregated dataset and the subset model and subset of similar customers;
compare the aggregated score to a variable threshold, wherein the variable threshold is determined according to a type of product offered and the credit offer requested; and
approve the request in real time if the aggregated score exceeds the variable threshold.

9. (canceled)

10. (canceled)

11. (canceled)

12. The system of claim 8, the instructions further cause the processor to reduce the plurality of combinations using techniques from a design of experiments.

13. The system of claim 8, the instructions further cause the processor to receive rankings of the scores for a subset of combinations from a panel input.

14. The system of claim 13, the instructions further cause the processor to generate aggregated input from the panel input, wherein the panel input is made of users.

15. A non-transitory computer readable medium having instruction to control processor configured to:
receive a request for an approval of a credit offer by a customer, wherein the credit offer is associated with a product offered by a financial institution;
continuously collect customer data of a set of customer accounts from external data sources and cloud data storage into an aggregated dataset, the set of customer accounts are associated with the financial institution, wherein the financial institution offers a set of products including at least the product associated with the credit offer;
generate a product score for each product offered by the financial institution, wherein each score contributes to a plurality of combinations of scores;
generate an aggregated model based on the aggregated customer data and the generated product score;
generate a subset model for a subset of similar customers, wherein generating the subset model comprises:
determining a data sampling representing a customer account
segmenting the field of customer accounts into subsets of similar customers;
modeling the data sampling using the aggregated model; and
determining variables that affect the subset model the most for each subset of similar customers;
determine an aggregated score using the aggregated model and the aggregated dataset and the subset model and subset of similar customers
compare the aggregated score to a variable threshold, wherein the variable threshold is determined according to a type of product offered and the credit offer requested; and
approve the request in real time if the aggregated score exceeds the variable threshold.

16. (canceled)

17. (canceled)

18. (canceled)

19. The non-transitory computer readable medium of claim 15, wherein the processors are further configured to:
reduce the plurality of combinations using techniques from a design of experiments.

20. The non-transitory computer readable medium of claim 15, wherein the processors are further configured to:
receive rankings of the scores for a subset of combinations from a panel input;
generating aggregated input from the panel input, wherein the panel input is made of users.
